(19) United States
(12) Patent Application Publication
(10) Pub. No.: US 2024/0175627 A1
(43) Pub. Date: May 30, 2024

(54) HYDROGEN LIQUEFACTION SYSTEM WITHOUT PRE-COOLING AND INTERGRATED LOSSLESS LIQUID HYDROGEN STORAGE SYSTEM

(71) Applicant: H2CREO Corp., Dover, DE (US)

(72) Inventors: Jong H Baik, Titusville, FL (US); Ho-Myung Chang, Seoul (KR)

(21) Appl. No.: 18/501,399

(22) Filed: Nov. 3, 2023

Related U.S. Application Data
(60) Provisional application No. 63/384,978, filed on Nov. 25, 2022.

(51) Int. Cl. F25J 1/02; F25J 1/00

(52) U.S. Cl. CPC F25J 1/0204; F25J 1/001; F25J 1/005; F25J 2270/16; F25J 2290/62

(57) ABSTRACT

A hydrogen liquefaction system without pre-cooling is disclosed. The hydrogen liquefaction system comprises: a first pipe set in which gaseous hydrogen supplied through a gaseous hydrogen buffer tank is liquefied into liquid hydrogen; a second pipe set through which refrigerant flows to exchange heat with gaseous hydrogen flowing through the first pipe set; a third pipe set through which refrigerant flows to exchange heat with gaseous hydrogen flowing through the first pipe set; a first heat exchanger and a second heat exchanger performing heat exchange between gaseous hydrogen flowing through the first pipe set and refrigerant flowing through the second pipe set and the third pipe set; and a third heat exchanger performing heat exchange between gaseous hydrogen flowing through the first pipe set and refrigerant flowing through the second pipe set.

### FIELD OF THE INVENTION

The present disclosure relates to a hydrogen liquefaction system without pre-cooling including a closed refrigeration cycle using one or more heat exchangers and one or more turbo expanders, producing liquid hydrogen by lowering temperature step by step by exchanging heat between refrigerant (e.g., helium) of the refrigeration cycle and hydrogen gas at room temperature that is introduced into the system through the heat exchangers which are located inside the system, and storing liquid hydrogen in a separate insulated liquid hydrogen storage tank, without a pre-cooling process for liquefying gaseous hydrogen. The present disclosure also relates to an integrated lossless liquid hydrogen storage system capable of being used to cool a storage tank by partially distributing the refrigerant (e.g., helium) of this hydrogen liquefaction system.

### BACKGROUND OF THE INVENTION

Conventional hydrogen liquefaction systems cool hydrogen at room temperature by additionally using material having a higher boiling point than hydrogen, such as liquid nitrogen or liquefied natural gas, as refrigerant. In this case, the liquid nitrogen is 77K, and the liquefied natural gas is 111K. For the hydrogen liquefaction system, an amount of liquid nitrogen or liquefied natural gas greater than an amount of liquid hydrogen to be liquefied is usually separately required. For example, in case of a hydrogen liquefaction system producing one ton of liquid hydrogen per day, seven to nine tons of liquid nitrogen per day is required as refrigerant for pre-cooling. In case of a distributed liquid hydrogen production base, a separate pre-cooling refrigerant production equipment is required in addition to the hydrogen liquefaction system, or a large amount of refrigerant for pre-cooling is required. This creates a big disadvantage in terms of facility construction and operation, due to such as increase in the area of a facility site, increase in facility price, accessibility and availability of refrigerant for pre-cooling, and the like.

In addition, conventional cryogenic storage tanks cannot completely block heat input from room temperature, such that some cryogenic liquid is evaporated, which increases internal pressure and reduces safety, and thus there is a disadvantage where loss of refrigerant cannot be avoided by releasing gas to atmosphere for pressure drop.

### SUMMARY OF THE INVENTION

The present disclosure relates to a hydrogen liquefaction system without pre-cooling capable of lowering temperature of gaseous hydrogen step by step without a pre-cooling process using liquid nitrogen or liquefied natural gas, by being provided with one or more heat exchangers and one or more turbo expanders.

In addition, the present disclosure relates to a hydrogen liquefaction system that does not use pre-cooling in which a first pipe set, through which gaseous hydrogen flows, is extended and stored in a liquid hydrogen storage tank so as to store liquid hydrogen produced by heat exchange between gaseous hydrogen and refrigerant (e.g., helium) without loss.

In addition, the present disclosure relates to an integrated lossless liquid hydrogen storage system in which a second pipe set through which refrigerant flows may be extended to a liquid hydrogen storage tank so as to absorb evaporation heat of liquid hydrogen stored in the liquid hydrogen storage tank in order to prevent liquid hydrogen stored in the liquid hydrogen storage tank from evaporating.

The purposes of the embodiments of the present disclosure are not limited to the above-mentioned purposes, and other purposes not mentioned above will be clearly understood by those skilled in the art to which the present disclosure pertains from the description below.

According to one aspect of the present disclosure, a hydrogen liquefaction system without pre-cooling based on refrigeration cycle may comprise: a first pipe set in which gaseous hydrogen supplied through a gaseous hydrogen buffer tank is liquefied into liquid hydrogen; a second pipe set through which refrigerant flows to exchange heat with gaseous hydrogen flowing through the first pipe set; a third pipe set through which refrigerant flows to exchange heat with gaseous hydrogen flowing through the first pipe set; a first heat exchanger and a second heat exchanger performing heat exchange between gaseous hydrogen flowing through the first pipe set and refrigerant flowing through the second pipe set and the third pipe set; and a third heat exchanger performing heat exchange between gaseous hydrogen flowing through the first pipe set and refrigerant flowing through the second pipe set, and wherein gaseous hydrogen is cooled by the first heat exchanger, the second heat exchanger, and the third heat exchanger to be liquefied into liquid hydrogen.

According to one embodiment according to the present disclosure, the first heat exchanger, the second heat exchanger, and the third heat exchanger may be sequentially provided in the direction in which gaseous hydrogen flows in the first pipe set.

According to one embodiment according to the present disclosure, the second pipe set and the third pipe set may form a refrigeration cycle of a closed loop.

According to one embodiment according to the present disclosure, the hydrogen liquefaction system without pre-cooling may further comprise: a first turbo expander provided in the second pipe set and located between the first heat exchanger and the second heat exchanger; a refrigerant compressor provided on one side of the second pipe set and one side of the third pipe set; and a second turbo expander provided on the other side of the second pipe set and the other side of the third pipe set.

According to one embodiment according to the present disclosure, the first heat exchanger may cool gaseous hydrogen by exchanging heat between gaseous hydrogen introduced from the gaseous hydrogen buffer tank and flowing through the first pipe set and refrigerant flowing through the second pipe set and the third pipe set.

According to one embodiment according to the present disclosure, the second heat exchanger may cool gaseous hydrogen by exchanging heat between gaseous hydrogen cooled while passing through the first heat exchanger and refrigerant flowing through the second pipe set and the third pipe set.

According to one embodiment according to the present disclosure, the third heat exchanger may cool gaseous hydrogen by exchanging heat between gaseous hydrogen cooled while passing through the second heat exchanger and refrigerant flowing through the third pipe set.

According to another aspect of the present disclosure, an integrated lossless liquid hydrogen storage system may comprise a liquid hydrogen storage tank for storing liquefied liquid hydrogen supplied from the first pipe set of the hydrogen liquefaction system described above, wherein an extended part of the second pipe set of the hydrogen liquefaction system branches and extends to the liquid hydrogen storage tank, and refrigerant flowing through the extended part of the second pipe set exchanges heat with liquid hydrogen stored in the liquid hydrogen storage tank to absorb evaporation heat of liquid hydrogen.

According to one embodiment according to the present disclosure, after refrigerant flowing through the extended part of the second pipe set exchanges heat with liquid hydrogen stored in the liquid hydrogen storage tank to absorb the evaporation heat of liquid hydrogen, refrigerant may be retrieved to the hydrogen liquefaction system.

In the present disclosure, since liquid nitrogen or liquefied natural gas used for pre-cooling in conventional hydrogen liquefaction devices is not used, a separate device or a separate refrigerant for pre-cooling is not required.

In addition, in the present disclosure, the hydrogen liquefaction system and the liquefied hydrogen storage system are integrated, which performs additional active cooling in the liquefied hydrogen storage tank and suppresses evaporation of the cryogenic refrigerant that normally occurs inside the cryogenic storage tank, thereby securing safety and greatly increasing a storage period.

Further, in the present disclosure, the present technology can supply a part of refrigerant of the liquefaction cycle to the storage tank to maintain temperature of the storage tank at liquefaction temperature, thereby preventing generation of evaporated gas as in the conventional re-liquefaction technology.

### BRIEF DESCRIPTION OF THE DRAWINGS

FIG. 1 is a view illustrating a hydrogen liquefaction system without pre-cooling according to an embodiment of the present disclosure.

FIG. 2 is a view illustrating an inside of a cold box of a hydrogen liquefaction system without pre-cooling and an integrated lossless liquid hydrogen storage system connected to this hydrogen liquefaction system according to an embodiment of the present disclosure.

FIG. 3A and FIG. 3B are views illustrating a temperature change of refrigerant (e.g., helium) in a hydrogen liquefaction system without pre-cooling according to an embodiment of the present disclosure.

### DESCRIPTION OF THE INVENTION

Advantages and characteristics of the embodiments of the present disclosure, and methods of achieving the same, will become clear with reference to the embodiments described below in detail along with the accompanying drawings. However, the present disclosure is not limited to the embodiments disclosed below and may be implemented in a variety of different forms. These embodiments are provided to make the disclosure of the present disclosure complete, and to fully inform those skilled in the art to which the present disclosure pertains of the scope of the disclosure, and the present disclosure will be defined only by the scope of the claims. The same reference signs designate the same components throughout the specification.

In describing the embodiments of the present disclosure, if it is determined that a detailed description of a known function or configuration may unnecessarily obscure the subject matter of the present disclosure, such detailed description will be omitted. In addition, terms to be described below are terms defined in consideration of functions in the embodiments of the present disclosure, which may vary according to an intention or custom of a user or operator. Therefore, definitions thereof should be made based on the contents throughout this specification.

Hereinafter, embodiments of the present disclosure will be described in detail with reference to the accompanying drawings.

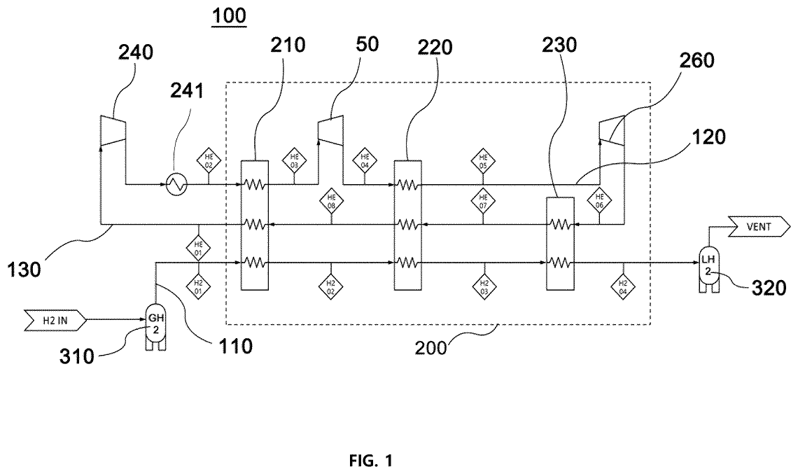

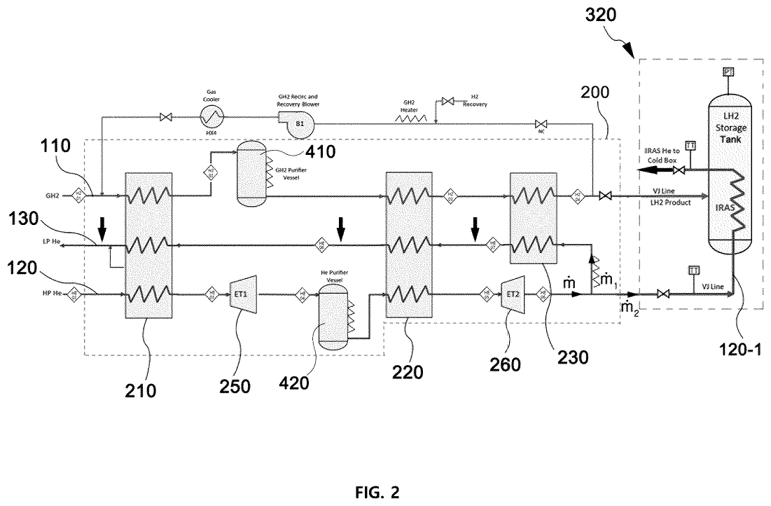

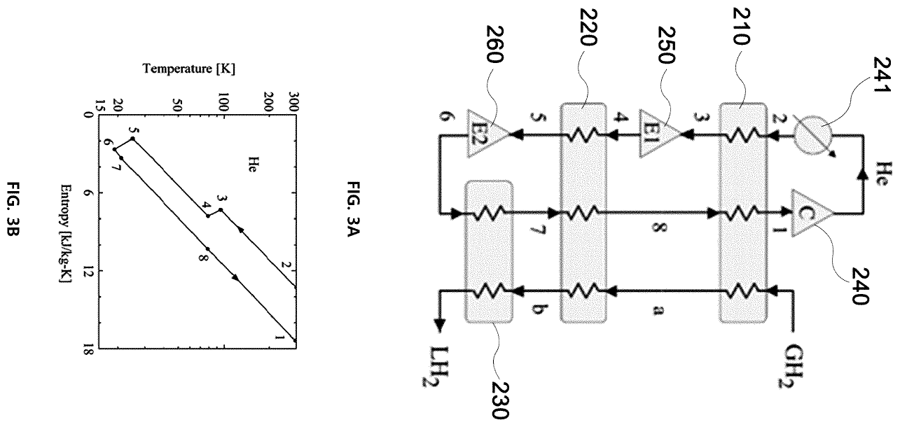

FIG. 1 is a view illustrating a hydrogen liquefaction system without pre-cooling according to an embodiment of the present disclosure; FIG. 2 is a view illustrating an inside of a cold box of a hydrogen liquefaction system without pre-cooling and an integrated lossless liquid hydrogen storage system connected to this hydrogen liquefaction system according to an embodiment of the present disclosure; and FIG. 3A and FIG. 3B are views illustrating a temperature change of refrigerant (e.g., helium) in a hydrogen liquefaction system without pre-cooling according to an embodiment of the present disclosure.

Referring to FIG. 1 to FIG. 3B, the hydrogen liquefaction system 100 without pre-cooling according to an embodiment of the present disclosure may include a first pipe set 110, a second pipe set 120, a third pipe set 130, a first heat exchanger 210, a second heat exchanger 220, a third heat exchanger 230, a refrigerant compressor 240, a first turbo expander 250, a second turbo expander 260, a gaseous hydrogen buffer tank 310, a liquid hydrogen storage tank 320, and the like.

The first pipe set 110 is a pipe through which gaseous hydrogen GH2 supplied through the gaseous hydrogen buffer tank 310 flows, and gaseous hydrogen GH2 may be liquefied into liquid hydrogen LH2 while flowing through the first pipe set 110 in an order of “H201”->“H202”->“H203”->“H204”. The first pipe set 110 according to an embodiment of the present disclosure may be provided with a first heat exchanger 210, a second heat exchanger 220, and a third heat exchanger 230. Gaseous hydrogen GH2 flowing through the first pipe set 110 may exchange heat with refrigerant (e.g., helium) flowing through the second pipe set 120 and the third pipe set 130 by the first heat exchanger 210, the second heat exchanger 220, and the third heat exchanger 230. That is, gaseous hydrogen GH2 flowing through the first pipe set 110 may exchange heat with refrigerant, and thus temperature of gaseous hydrogen GH2 may drop. In addition, refrigerant flowing through the second pipe set 120 and the third pipe set 130 may exchange heat with gaseous hydrogen GH2 in an order of “H201”->“H202”->“H204”->“H205”->“H206”->“H208”. In other words, refrigerant (e.g., helium) flowing through the second pipe set 120 and the third pipe set 130 forms an independent refrigeration cycle that does not mix with the gas hydrogen flowing through the first pipe set 110, thereby temperature of gaseous hydrogen GH2 in the first pipe set 110 is gradually reduced through the first heat exchanger 210, the second heat exchanger 220, and the third heat exchanger 230.

Further, the first pipe set 110 according to an embodiment of the present disclosure may be combined with the liquid hydrogen storage tank 320. Therefore, liquid hydrogen LH2 liquefied by flowing through the first pipe set 110 may be stored in the liquid hydrogen storage tank 320.

The second pipe set 120 is a pipe through which refrigerant flows to exchange heat with gaseous hydrogen GH2 flowing through the first pipe set 110. The second pipe set 120 according to an embodiment of the present disclosure may be provided with a first heat exchanger 210 and a second heat exchanger 220. Refrigerant flowing through the second pipe set 120 may exchange heat with gaseous hydrogen GH2 flowing through the first pipe set 110 by the first heat exchanger 210 and the second heat exchanger 220. That is, refrigerant flowing through the second pipe set 120 may exchange heat with gaseous hydrogen GH2, and thus temperature of refrigerant may rise. In addition, gaseous hydrogen GH2 flowing the first pipe set may exchange heat with refrigerant, and thus temperature of gaseous hydrogen GH2 may drop.

Further, the second pipe set 120 according to an embodiment of the present disclosure may be provided with a second turbo expander 260 on the other side, and a first turbo expander 250 may be provided between the first heat exchanger 210 and the second heat exchanger 220. Refrigerant flowing through the second pipe set 120 may be expanded by the first turbo expander 250 and the second turbo expander 260. That is, refrigerant may be expanded while passing through the first turbo expander 250 and the second turbo expander 260, and thus temperature of refrigerant may be decreased.

In addition, an extended part 120-1 of the second pipe set 120 may extend to the liquid hydrogen storage tank 320. That is, the extended part 120-1 of the second pipe set 120 may be spaced apart from an outer surface of the liquid hydrogen storage tank 320 by a predetermined distance, or provided to directly contact the outer surface of the liquid hydrogen storage tank 320. Refrigerant flowing through the second pipe set 120 having the extended part 120-1 may exchange heat with liquid hydrogen LH2 stored in the liquid hydrogen storage tank 320, thereby absorbing evaporation heat of liquid hydrogen LH2. Accordingly, it is possible to prevent liquid hydrogen LH2 stored in the liquid hydrogen storage tank 320 from vaporizing.

Cold refrigerant (e.g., helium (He)) that moves to the liquid hydrogen storage tank 320 and then absorbs evaporation heat may be returned to the second pipe set 120 or the third pipe set 130 in a refrigerant cycle, as indicated by arrows in FIG. 2. In this way, a system adopting a method that refrigerant flowing through the second pipe set 120 exchanges heat with liquid hydrogen LH2 of the liquid hydrogen storage tank 320 to absorb the evaporation heat, and the cold refrigerant absorbed this evaporation heat is returned to the second pipe set 120 or the third pipe set 130 in a refrigerant cycle is called an integrated lossless liquid hydrogen storage system.

A ratio of the refrigerant flowing through the second pipe set 120 to the liquid hydrogen storage tank 320 through the extension 120-1 of the second pipe set 120, Y is as follows:

$$Y = \frac{{\dot{m}}_{2}}{\dot{m}} m = {\dot{m}}_{1} + {\dot{m}}_{2}$$

$$0 < Y < 1$$

According to the flow rate branching into the liquid hydrogen storage tank 320, ratio Y may be expressed as a value between 0 and 1.

When Y=0, the hydrogen liquefaction system 100 serves only as a liquefier, and when Y=1, the hydrogen liquefaction system 100 can only serve as a cooler for cooling the liquid hydrogen storage tank 320.

Also, as Y=1 approaches, the temperature at the rear end of the second turbo expander 260 may be lower than in the present embodiment.

Also, as Y approaches 1, temperature at a rear end of the second turbo expander 260 may be lowered.

In FIG. 2, “IRAS” is an abbreviation of “Integrated Refrigeration and Storage”, and “VJ” is an abbreviation of “Vacuum Jacketed”.

The third pipe set 130 is a pipe through which refrigerant flows to exchange heat with gaseous hydrogen GH2 flowing through the first pipe set 110. The third pipe set 130 according to an embodiment of the present disclosure may be provided with a first heat exchanger 210, a second heat exchanger 220, and a third heat exchanger 230. Refrigerant flowing through the third pipe set 130 may exchange heat with gaseous hydrogen GH2 flowing through the first pipe set 110 by the third heat exchanger 230, the second heat exchanger 220, and the first heat exchanger 210 sequentially. That is, refrigerant flowing through the third pipe set 130 may exchange heat with gaseous hydrogen GH2, and thus temperature of refrigerant may rise. In addition, gaseous hydrogen GH2 flowing the first pipe set may exchange heat with refrigerant, and thus temperature of gaseous hydrogen GH2 may drop. Meanwhile, “410” and “420” in FIG. 2 are purifier vessels and serve to remove impurities in hydrogen or refrigerant.

The second pipe set 120 and the third pipe set 130 according to an embodiment of the present disclosure may be formed as a closed loop. That is, each end of the second pipe set 120 and each end of the third pipe set 130 are connected to form a ring, so that refrigerant may continuously flow inside the second pipe set 120 and the third pipe set 130. In addition, refrigerant may flow through the inside of the connected second pipe set 120 and the third pipe set 130, and may exchange heat with gaseous hydrogen GH2 by the first heat exchanger 210, the second heat exchanger 220, and the third heat exchanger 230. Accordingly, temperature of gaseous hydrogen GH2 is gradually decreased such that gaseous hydrogen GH2 may be liquefied into liquid hydrogen LH2. That is, during flowing through the second pipe set 120 according to an embodiment of the present disclosure, temperature of refrigerant may be decreased while refrigerant passes through the first turbo expander 250 and the second turbo expander 260. And during flowing through the third pipe set 130, temperature of refrigerant may be increased while refrigerant passes through the first heat exchanger 210, the second heat exchanger 220, the third heat exchanger 230, and the refrigerant compressor 240. The above refrigerant process may be repeated cyclically.

Referring to FIG. 3A and FIG. 3B and Table 1 below, changes in temperature, entropy, etc. of refrigerant (e.g., helium (He)) flowing through the second pipe set 120 and the third pipe set 130, and changes in temperature, pressure, etc. of hydrogen H2 flowing through the first pipe set 110, can be checked. FIG. 3A is a diagram showing temperature change of refrigerant in relation to operation of the first to third heat exchangers 210, 220, 230 and the first and second turbo-expanders 250, 260, and FIG. 3B is a diagram showing temperature change of refrigerant based on entropy.

Referring to FIG. 3A and FIG. 3B together with FIG. 1, changes in temperature, entropy, etc. of refrigerant (e.g., helium (He)) flowing through the second pipe set 120 and the third pipe set 130 can be checked. Processes 1 and 2 are processes in which refrigerant is compressed by the refrigerant compressor 240. Temperature of refrigerant compressed by the refrigerant compressor 240 may be further reduced while passing through an aftercooler 241. Processes 2 to 3 and 8 to 1 are processes in which gaseous hydrogen GH2 flowing through the first pipe set 110 exchanges heat with refrigerant flowing through the second pipe set 120 and the third pipe set 130 by the first heat exchanger 210. Processes 3 to 4 are processes in which refrigerant flowing through the second pipe set 120 is expanded by the first turbo expander 250. Processes 4 to 5 and 7 to 8 are processes in which gaseous hydrogen GH2 flowing through the first pipe set 110 exchanges heat with refrigerant flowing through the second pipe set 120 and the third pipe set 130 by the second heat exchanger 220. Processes and 5 to 6 are processes in which refrigerant flowing through the second pipe set 120 is expanded by the second turbo expander 260. Processes 6 to 7 are processes in which gaseous hydrogen GH2 flowing through the third pipe set 130 exchanges heat with refrigerant flowing through the third pipe set 130 by the third heat exchanger 230.

In addition, referring to Table 1 below, changes in temperature, pressure, etc. of hydrogen H2 flowing through the first pipe set 110 can be checked. Gaseous hydrogen GH2 flowing into the first pipe set 110 at a temperature of about 300K may flow through the first pipe set 110, and may exchange heat with refrigerant by the first heat exchanger 210, the second heat exchanger 220, and the third heat exchanger 230. That is, temperature of gaseous hydrogen GH2 may decrease from about 300K to about 94K while passing through the first heat exchanger. In addition, temperature of gaseous hydrogen GH2 may decrease from about 94K to about 25K while passing through the second heat exchanger 220. Further, temperature of gaseous hydrogen GH2 may decrease from about 25K to about 20K while passing through the third heat exchanger 230. As temperature at which gaseous hydrogen GH2 is liquefied into liquid hydrogen LH2 is about 21K, temperature of gaseous hydrogen GH2 flowing into the first pipe set 110 at a temperature of about 300K may be gradually lowered to about 20K, thereby being liquefied into liquid hydrogen LH2.

TABLE 1

| | 1 | 2 | 3 | 4 | 5 | 6 |
|---|---|---|---|---|---|---|
| Temperature | 295.5 | 300.0 | 94.94 | 78.92 | 25.07 | 19.00 |
| [K] | | | | | | |
| Pressure | 0.135 | 1.000 | 0.990 | 0.495 | 0.485 | 0.165 |
| [MPa] | | | | | | |
| | 7 | 8 | GH₂ | a | b | LH₂ |
| Temperature | 21.09 | 78.50 | 300.0 | 94.94 | 25.07 | 20.96 |
| [K] | | | | | | |
| Pressure | 0.155 | 0.145 | 0.150 | 0.140 | 0.130 | 0.120 |
| [MPa] | | | | | | |

Referring to FIG. 1 and FIG. 2, the first heat exchanger 210, the second heat exchanger 220, the third heat exchanger 230, the first turbo expander 250, the second turbo expander 260 and the like may be accommodated in a cold box 200. The cold box 200 is a housing in which its inside is maintained in a vacuum state below room temperature. The cold box 200 isolates components accommodated inside it from the external environment so that the components accommodated inside it can perform functions without being affected by external environmental factors such as temperature, pressure and the like. Accordingly, inside the cold box 200, the first heat exchanger 210 and the second heat exchanger 220 may perform heat exchange between gaseous hydrogen GH2 and refrigerant, and the first turbo expander 250 and the second turbo expander 260 may expand refrigerant.

Referring to FIG. 1, the first pipe set 110, the second pipe set 120, and the third pipe set 130 of the hydrogen liquefaction system 110 without pre-cooling according to an embodiment of the present disclosure may be provided with one or more pressure transmitters (PT) and one or more temperature transmitters (TT). Accordingly, the pressure and temperature of gaseous hydrogen GH2 flowing through the first pipe set 110 and refrigerant flowing through the second pipe set 120 and the third pipe set 130 may be measured for each section of the pipe sets.

In addition, the hydrogen liquefaction system 100 that does not use pre-cooling, according to an embodiment of the present disclosure, may be configured by disposing an Ortho-Para (OP) conversion catalyst in the heat exchangers 210, 220, 230 on the first pipe set 110 or at any part between the heat exchangers 210, 220, 230 and the expanders 250 and 260.

Although the above has shown and described various embodiments of the present disclosure, the present disclosure is not limited to the specific embodiments described above. The above-described embodiments can be variously modified and implemented by those skilled in the art to which the present invention pertains without departing from the gist of the present disclosure claimed in the appended claims, and these modified embodiments should not be understood separately from the technical spirit or scope of the present disclosure. Therefore, the technical scope of the present disclosure should be defined only by the appended claims.

In the embodiments disclosed herein, arrangement of illustrated components may vary depending on requirements or environment in which the invention is implemented. For example, some components may be omitted or some components may be integrated and implemented as one.

For example, the number of heat exchangers, refrigerant compressors, and turbo expanders described in this disclosure represents a preferred embodiment, and those skilled in the art would understand that within the scope of the present disclosure, any number of heat exchangers, refrigerant compressors, or turbo expanders may be used, as long as they do not deviate from the spirit of the invention.

Furthermore, parallel or series arrangement of the heat exchangers, refrigerant compressors, and turbo expanders described in this disclosure represents a preferred embodiment, and those skilled in the art would understand that within the scope of the present invention, alternative parallel or series arrangements are also possible.

Additionally, the function of liquefying the refrigerant's liquid hydrogen described in this disclosure represents a preferred embodiment, and those skilled in the art would understand that within the scope of the present invention, the refrigerant can also contribute to cooling by condensation of the evaporated gas and can aid in supercooling the liquid hydrogen to even lower temperatures.

What is claimed is:

1. A hydrogen liquefaction system without pre-cooling based on a refrigeration cycle comprising:
a first pipe set in which gaseous hydrogen supplied through a gaseous hydrogen buffer tank is liquefied into liquid hydrogen;
a second pipe set through which refrigerant flows to exchange heat with gaseous hydrogen flowing through the first pipe set;
a third pipe set through which refrigerant flows to exchange heat with gaseous hydrogen flowing through the first pipe set;
a first heat exchanger and a second heat exchanger performing heat exchange between gaseous hydrogen flowing through the first pipe set and refrigerant flowing through the second pipe set and the third pipe set; and
a third heat exchanger performing heat exchange between gaseous hydrogen flowing through the first pipe set and refrigerant flowing through the second pipe set, and
wherein gaseous hydrogen is cooled by the first heat exchanger, the second heat exchanger, and the third heat exchanger to be liquefied into liquid hydrogen.

2. The hydrogen liquefaction system without pre-cooling according to claim 1,
wherein the first heat exchanger, the second heat exchanger, and the third heat exchanger are sequentially provided in a direction in which gaseous hydrogen flows in the first pipe set.

3. The hydrogen liquefaction system without pre-cooling according to claim 2,
wherein the second pipe set and the third pipe set form a refrigeration cycle of a closed loop.

4. The hydrogen liquefaction system without pre-cooling according to claim 3, further comprising:
a first turbo expander provided in the second pipe set and located between the first heat exchanger and the second heat exchanger;
a refrigerant compressor provided on one side of the second pipe set and one side of the third pipe set; and
a second turbo expander provided on the other side of the second pipe set and the other side of the third pipe set.

5. The hydrogen liquefaction system without pre-cooling according to claim 4,
wherein the first heat exchanger cools gaseous hydrogen by exchanging heat between gaseous hydrogen introduced from the gaseous hydrogen buffer tank and flowing through the first pipe set and refrigerant flowing through the second pipe set and the third pipe set.

6. The hydrogen liquefaction system without pre-cooling according to claim 5,
wherein the second heat exchanger cools gaseous hydrogen by exchanging heat between gaseous hydrogen cooled while passing through the first heat exchanger and refrigerant flowing through the second pipe set and the third pipe set.

7. The hydrogen liquefaction system without pre-cooling according to claim 6,
wherein the third heat exchanger cools gaseous hydrogen by exchanging heat between gaseous hydrogen cooled while passing through the second heat exchanger and refrigerant flowing through the third pipe set.

8. An integrated lossless liquid hydrogen storage system, comprising:
a liquid hydrogen storage tank for storing liquefied liquid hydrogen supplied from the first pipe set of the hydrogen liquefaction system according to claim 1, and
wherein an extended part of the second pipe set of the hydrogen liquefaction system branches and extends to the liquid hydrogen storage tank, and refrigerant flowing through the extended part of the second pipe set exchanges heat with liquid hydrogen stored in the liquid hydrogen storage tank to absorb evaporation heat of liquid hydrogen.

9. The integrated lossless liquid hydrogen storage system according to claim 8,
wherein, after refrigerant flowing through the extended part of the second pipe set exchanges heat with liquid hydrogen stored in the liquid hydrogen storage tank to absorb the evaporation heat of liquid hydrogen, refrigerant is retrieved to the hydrogen liquefaction system.
